(19) United States
(12) Patent Application Publication
(10) Pub. No.: US 2013/0322972 A1
(43) Pub. Date: Dec. 5, 2013

(54) PNEUMATIC AIR CONVEYANCE TECHNOLOGY

(71) Applicant: Charles L. Lloyd, Milton, WA (US)

(72) Inventor: Charles L. Lloyd, Milton, WA (US)

(73) Assignee: LFIP Holdings Pty. Ltd.

(21) Appl. No.: 13/489,318

(22) Filed: Jun. 5, 2012

(51) Int. Cl. B65G 53/08

(52) U.S. Cl. 406/61

(57) ABSTRACT

Multi-stage pneumatic conveying apparatus for separating materials and associated systems and methods are described herein. The pneumatic conveying apparatus can include an inner barrel, an outer barrel, a hopper, a screw and a nose cone. The inner barrel can include inner baffles on its outer surface. The outer barrel can accommodate the inner barrel and include outer baffles on its inner surface. The hopper can include an opening in fluid communication with the inner barrel and can receive materials into the inner barrel. The screw conveyor assembly can be within the inner barrel and transport materials toward the outer barrel. The nose cone can include a plurality of nose cone components on its inner surface. The materials can be transported from the outer barrel to the nose cone via air flow from an external source.

### TECHNICAL FIELD

The present technology relates generally to a multi-stage pneumatic conveying apparatuses and associated systems and methods. Several aspects of the present technology, more specifically, are directed toward a modularized pneumatic conveyor configured to deliver and separate a variety of different types of materials.

### BACKGROUND

Material delivery plays an important role in all engineering projects. The delivery routes of materials in different projects can be drastically different because of different working conditions. Thus, it is advantageous to have an apparatus or system with certain flexibility to satisfy different delivery needs, such as distance, altitude drop, and/or working space for installation the apparatus or system. In addition, some engineering projects may have more specific or stricter requirements for purity of materials.

### BRIEF DESCRIPTION OF THE DRAWINGS

FIG. 1 is a schematic view illustrating a multi-stage pneumatic apparatus configured in accordance with an embodiment of the present technology.

FIG. 2 is a partially schematic, exploded isometric view illustrating an outer barrel and a bearing pod configured in accordance with an embodiment of the present technology.

FIG. 3 is a partially schematic, exploded isometric view illustrating an inner barrel configured in accordance with an embodiment of the present technology.

FIG. 4A is a schematic, cross-sectional view of inner baffles of an inner barrel and outer baffles of the outer barrel configured in accordance with an embodiment of the present technology.

FIG. 4B is a schematic view illustrating a baffle angle between an air flow and a baffle configured in accordance with an embodiment of the present technology.

FIG. 5A is a schematic, cross-sectional view illustrating a portion of a nose cone chamber configured in accordance with an embodiment of the present technology.

FIG. 5B is a schematic, cross-sectional view illustrating a nose cone component configured in accordance with an embodiment of the present technology.

FIG. 6 is a flowchart illustrating a method for conveying and separating materials configured in accordance with an embodiment of the present technology.

### DETAILED DESCRIPTION

The following disclosure describes various embodiments of multi-stage pneumatic apparatuses and associated systems and methods. As described in greater details below, a multi-stage pneumatic apparatus for conveying and separating materials configured in accordance with an embodiment of the present technology can include an inner barrel including a plurality of inner baffles on its outer surface and an outer barrel configured to accommodate the inner barrel. The outer barrel can include a plurality of outer baffles on its inner surface. The apparatus may also include a hopper having an opening in fluid communication with the inner barrel, a screw conveyor assembly configured to transport materials received from the hopper toward the outer barrel, and a nose cone including a plurality of nose cone components on its inner surface. The inner surface of the nose cone defines, at least a part, a nose cone chamber. Materials to be conveyed using the apparatus may be first delivered to the screw conveyor assembly within the inner barrel, and then transported to the nose cone via air flow from an external source in fluid communication with the outer barrel. The air flow can facilitate transport of the materials based, at least in part, on a siphon effect.

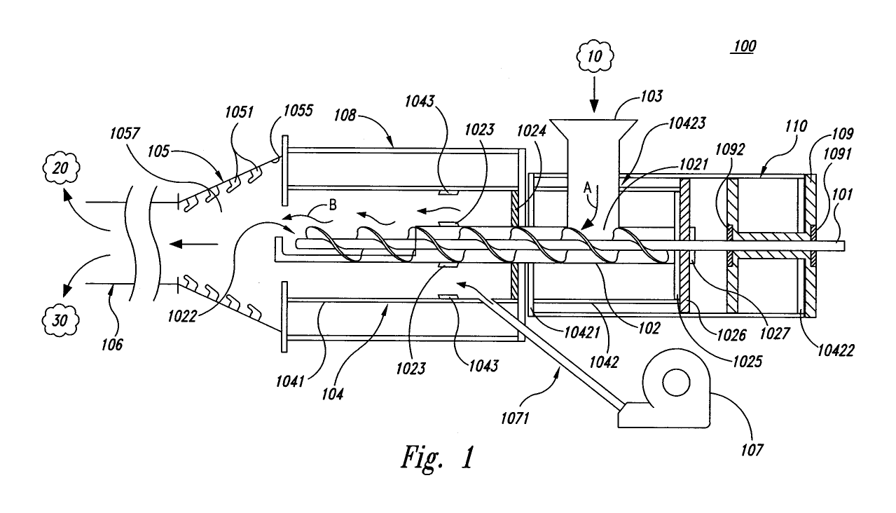

Certain details are set forth in the following description and in FIGS. 1-6 to provide a thorough understanding of various embodiments of the disclosure. Other details describing well-known structures and systems often associated with conveying apparatus, however, have not been set forth in the following disclosure to avoid unnecessarily obscuring the description of the various embodiments of the disclosure.

Many of the details, dimensions, angles and other features shown in the Figures are merely illustrative of particular embodiments of the disclosure. Accordingly, other embodiments can have other details, dimensions, angles and features without departing from the spirit or scope of the present disclosure. In addition, those of ordinary skill in the art will appreciate that further embodiments of the disclosure can be practiced without several of the details described below.

FIG. 1 is a schematic view illustrating a multi-stage pneumatic apparatus 100 configured in accordance with an embodiment of the present technology. As shown in FIG. 1, the multi-stage pneumatic apparatus 100 is configured to convey materials 10 for a distance (e.g., ranging from a few meters to hundreds of meters). In some embodiments, the materials 10 can be a mixture of sand and water. In other embodiments, the materials 10 can include sands, mineral ores, coals, clay, lime, fly ash, water or other natural or industrial materials. In one particular embodiment, the materials 10 to be conveyed or delivered can have a wide spectrum of granularity (e.g., ranging from about 3 inches (7.62 centimeter) to about 260 micrometer). In other embodiments, however, the materials 10 may have other sizes and/or arrangements. The apparatus 100 can be operated at a relatively low air pressure (e.g., approximately 1 to 8 psi). The apparatus 100 can include a screw conveyor assembly 101, an inner barrel 102, a hopper 103, an outer barrel 104, a nose cone 105, a pipeline 106, and an air blower 107. In the illustrated embodiment, the screw conveyor assembly 101 can be a screw shaft, an Archimedes' screw, or a screw-pump that can be rotated by a power source (not shown in FIG. 1) and can deliver materials 10 through its rotation. In other embodiments, however, the screw conveyor assembly 101 can include devices or mechanisms with similar function.

In the illustrated embodiment, the inner barrel 102 can be configured to have a first opening 1021 and a second opening 1022. In some embodiments, the shape of the first opening 1021 can be adjusted to accommodate different types of hoppers 103. For example, the first opening 1021 can have a circular cross-sectional opening perpendicular to a longitudinal axis (e.g., the shaft direction) of the inner barrel 102. In other embodiments, however, the first opening 1021 can have different shapes and/or arrangements.

In the embodiment illustrated in FIG. 1, the inner barrel 102 can be configured to accommodate the screw conveyor assembly 101. Further, the hopper 103 may be configured to fluidly connect with the inner barrel 102. This can allow the materials 10 to be placed into the inner barrel 102 (e.g., as shown by the arrow “A” in FIG. 1) through the hopper 103 and the first opening 1021. In the illustrated embodiment, the hopper 103 comprises a funnel-shaped device. In other embodiments, however, the hopper 103 may have a different features and/or a different configuration suitable for delivering the materials 10 into the inner barrel 102.

As shown in FIG. 1, the outer barrel 104 can be configured to accommodate the inner barrel 102. In the illustrated embodiment, for example, the outer barrel 104 includes a first section 1041 and a second section 1042. As shown in FIG. 1, the first opening 1021 of the inner barrel 102 can be positioned in the second section 1042 of the outer barrel 104, and the second opening 1022 of the inner barrel 102 can be positioned in the first section 1041 of the outer barrel 104. In other embodiments, however, the first section 1041 and the second section 1042 can be formed as an integral component. In the illustrated embodiment, the first section 1041 and the second section 1042 can be connected by nuts and bolts. In other embodiments, however, the first section 1041 and the second section 1042 may be coupled together using other suitable means (e.g., by glues or wedges, etc.). The operational air pressure within the first section 1041 of the outer barrel 104 can be relatively low (e.g., from 1 to 4 psi, which is lower than ambient air pressure, generally around 14 to 15 psi).

In the illustrated embodiment, the first section 1041 of the outer barrel 104 can be positioned in the air chamber 108. The air chamber 108 is configured to maintain an operational air pressure inside the outer barrel 104. As discussed above, because the operational air pressure is relatively low, the air chamber 108 can act as, for example, an air-pressure buffer zone to prevent accidental pressure changes due to accidents (e.g., leakage).

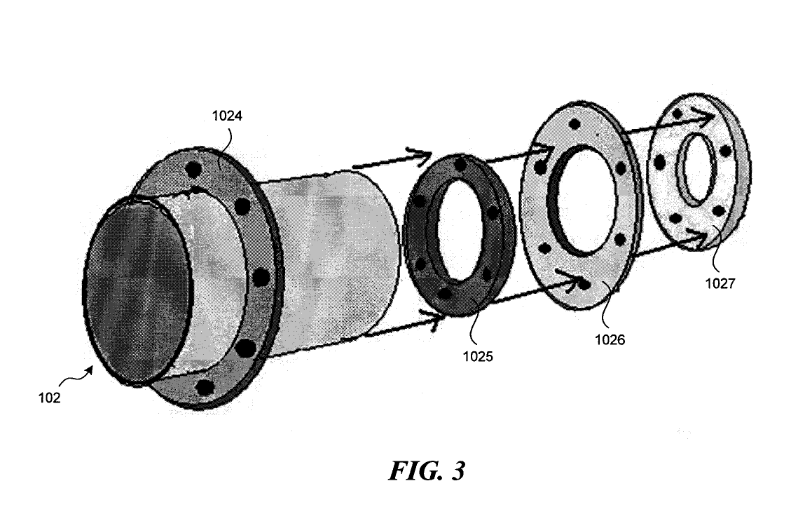

In the embodiment shown in FIG. 1, the inner barrel 102 and the outer barrel 104 can be connected by an attachment plate 1024. The attachment plate 1024, for example, can enhance the structural rigidity of the apparatus 100 and also can allow users to easily attach or detach the inner barrel 102 and the outer barrel 104. Further details regarding embodiments of the attachment plate 1024 are described with reference to FIG. 3.

The air blower 107 can be fluidly connected with the outer barrel 104 and configured to generate an air flow between the inner barrel 102 and an outer barrel 104. In other embodiments, the apparatus 100 can also include one or more air suction devices (not shown). In other embodiments, the apparatus 100 may include a different number of air blowers 107 (or air suction devices). In the illustrated embodiment, the air blower 107 can send the air flow into the out barrel 104 via a conduit 1071. The conduit 1071 can pass through the air chamber 108 and then connects with the outer barrel 104. In the illustrated embodiment, the conduit 1071 and the outer barrel 104 can form an injection angle of around 45 degree. In other embodiments, however, the injection angle can vary.

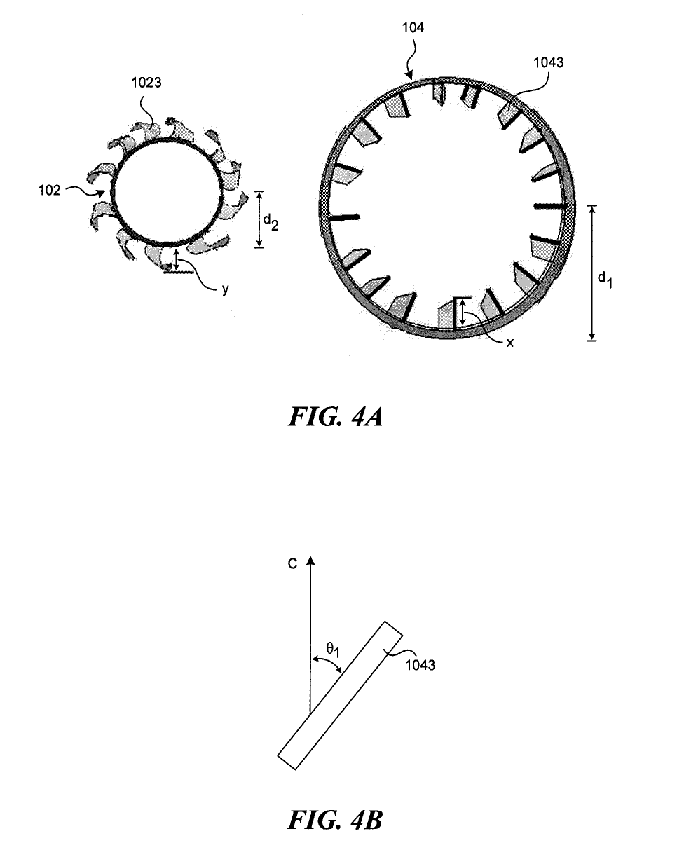

In the illustrated embodiment, the inner barrel 102 can have a plurality of inner baffles 1023 positioned on its outer surface, and the outer barrel 104 can have a plurality of outer baffles 1043 positioned on its inner surface. The inner baffles 1023 and the outer baffles 1043 are configured to (a) guide the air flow from the air blower 107, and (b) generate turbulence or vortex in the air flow and thereby enable the air flow to pick up the materials 10 at the second opening 1022 of the inner barrel 102 (e.g., as shown by the arrow “B” in FIG. 1) via a siphon effect (e.g., due to the air pressure difference between the inner barrel 102 and the outer barrel 104). Further details regarding embodiments of the inner baffles 1023 and the outer baffles 1043 are described with reference to FIGS. 4A-4B.

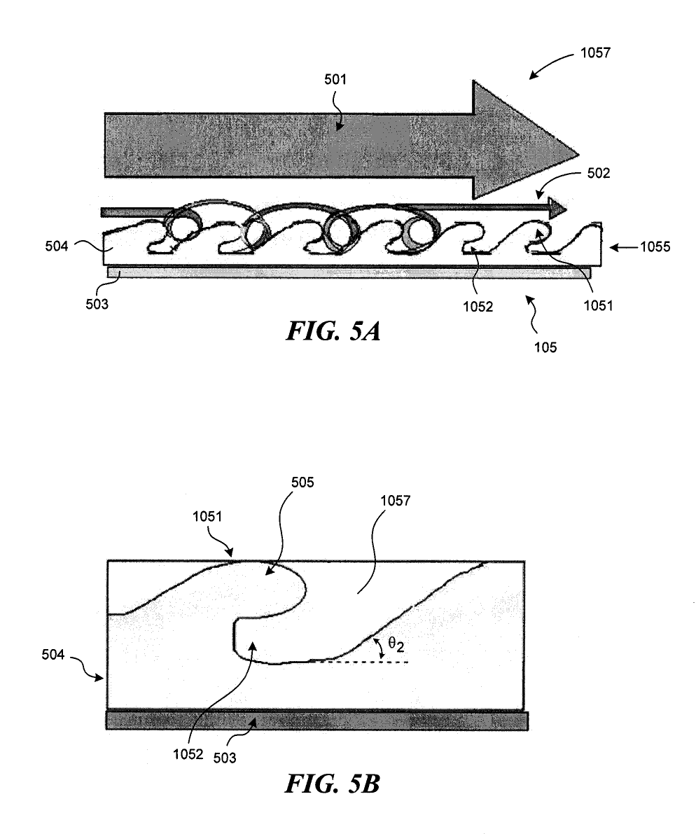

As shown in FIG. 1, after picking up the materials 10, the air flow can transport the materials 10 to the pipeline 106 through a nose cone 105. In the illustrated embodiment, the nose cone 105 comprises an inner surface 1055 defining, at least a part, a nose cone chamber 1057. The nose cone 105 can also include a plurality of nose cone components 1051 positioned on the inner surface. The air flow can be accelerated while passing through the nose cone chamber 1057 and the operative air pressure can be increased (e.g., around 6-8 psi). The plurality of nose cone components 1051, for example, can be positioned to generate a cyclonic effect that is expected to (1) reduce an inner surface friction force of the nose cone chamber 1057 and thereby enhance the air flow passing through the nose cone chamber 1057; (2) prevent accumulation of sediments (e.g., hydrated sediments) on the inner surface of the nose cone chamber 1057; and (3) facilitate the separation of materials 10 in the pipeline 106. Further details regarding embodiments of the nose cone component 1051 are described with reference to FIGS. 5A and 5B.

The accelerated air flow is configured to transport the materials 10 into the pipeline 106. The portion of the pipeline 106 shown in FIG. 1 is for illustration only. It will be appreciated that the pipeline 106 can have any suitable length (e.g., from a few meters to hundreds of meters or more). In the illustrated embodiment, the operative air pressure in the pipeline can be relatively low (e.g., around 1-4 psi). The pipeline 106 is configured to deliver the materials 10 to a predetermined destination. Further, in some instances, the pipeline 106 may be configured such that the materials 10 can be separated into a first set of material 20 (shown schematically) and a second set of material 30 (shown schematically) during transport. In the illustrated embodiment, for example, the materials 10 can be separated in the pipeline 106, at least in part, because of the cyclonic effect created by the nose cone components 1051. The cyclonic effect can randomly cause the particles of the materials 10 to move. The particles of the materials 10 can then be separated due to their different weights. For example, heavier particles (i.e., particles relatively difficult to be moved by turbulence) tend to travel in the center of the air flow while lighter particles (i.e., particles relatively easy to be moved by turbulence) can be moved away from the center of the air flow. The first set of material 20 and the second set of material 30 can be directed to different storages (not shown) for further processing or use. In other embodiments, the materials 10 passing through the pipeline 106 may be separated into more than two sets of materials. Further, in some embodiments the separation process can also be used to remove moisture of the materials 10.

In the illustrated embodiment, the inner barrel 102 may be coupled with the outer barrel 104 via a shoe plate 1025 and a hopper plate 1026. A seal plate 1027 can further connect with the hopper plate 1026 to secure the inner barrel 102 with the hopper plate 1026. The shoe plate 1025, for example, is positioned to help maintain a substantially air-tight condition in the inner barrel 102 and the outer barrel 104. The hopper plate 1026 is positioned to help maintain a substantially air-tight condition in the outer barrel 104 (and a main barrel 110). In some embodiments, the inner barrel 102 can be directly coupled with the hopper plate 1026, by which a substantially air-tight condition in the inner barrel 102 can be maintained. Further details regarding embodiments of the shoe plate 1025, the hopper plate 1026 and the seal plate 1027 are described with reference to FIG. 3.

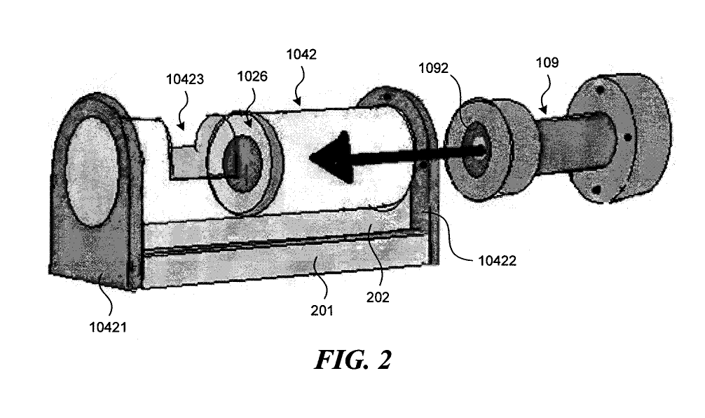

In the embodiment shown in FIG. 1, the outer barrel 104 may be coupled with a main barrel 110 by the hopper plate 1026 and a front plate 10421. The main barrel 110, for example, can accommodate the outer barrel 104 and is positioned to help maintain a substantially air-tight condition in the outer barrel 104. The main barrel 110 can act like an air-pressure buffer zone to prevent an accidental pressure change to the outer barrel 104. In the illustrated embodiment, the main barrel 110 can also accommodate a bearing rod 109. The main barrel 110 may be operably coupled with the screw conveyor assembly 101 via the back plate 10422 and the bearing rod 109. The bearing rod 109 and the back plate 10422 are positioned to help maintain a substantially air-tight condition in the main barrel 110. In the illustrated embodiment, the bearing rod 109 may be coupled with the screw conveyor assembly 101. As shown in FIG. 1, two sealing portions 1091 and 1092 can also facilitate maintaining a substantially air-tight condition in the main barrel 110 when the screw conveyor assembly 101 rotates. Further details regarding embodiments of the bearing pod 109 are described with reference to FIG. 2.

In some embodiments, a number of the elements of the apparatus 100 may be modularized to allow the apparatus 100 to be easily transported and set up for operation in a variety of different types of working environments. For example, the apparatus 100 can have several sets of elements with different sizes (e.g., diameters or lengths) to be chosen by users, depending on the conditions of the working environments. Further, the elements of the modularized apparatus 100 can be easy installed or replaced when necessary (e.g., for worn or broken elements). In some embodiments, for example, the elements of the modularized apparatus 100 can be easily connected and fastened together (e.g., using nuts and bolts). In other embodiments, the elements of the modularized apparatus 100 can be easily coupled together using other similar mechanisms.

FIG. 2 is a partially schematic, exploded isometric view illustrating an outer barrel 104 and a bearing pod 109 configured in accordance with an embodiment of the present technology. As shown in FIG. 2, the second portion 1042 of the outer barrel 104 can include a hopper opening 10423 configured to accommodate the hopper 103 (not shown in FIG. 2) and to allow the materials 10 to come into the outer barrel 104. In this embodiment, the second portion 1042 of the outer barrel 104 can be supported by a base 201 and a supporting device 202. The front plate 10421 and the back plate 10422 can also support the second portion 1042 of the outer barrel 104 at two ends. In the illustrated embodiment, the hopper plate 1026 can be positioned inside the second portion 1042 of the outer barrel 104 and connect with the inner barrel 102 (not shown in FIG. 2). The hopper plate 1026 may be positioned to help maintain a substantially air-tight condition in the second portion 1042 of the outer barrel 104. In the illustrated embodiment, the bearing rod 109 can include a sealing portion 1092 in its center to accommodate the screw conveyor assembly 101 (not shown in FIG. 2). The bearing rod 109 with the sealing portion 1092 is arranged to help maintain the position of the screw conveyor assembly 101 when the screw conveyor assembly rotates. In the illustrated embodiment, the bearing rod 109 and the screw conveyor assembly 101 can be positioned in and fixed with the outer barrel 104 by attaching the bearing rod 109 with the back plate 10422 (e.g., using nuts and bolts). In other embodiments, the bearing rod 109 and the screw conveyor assembly 101 can be easily detached from the outer barrel 104. The bearing rod 109 may also help maintain a substantially air-tight condition in the second portion 1042 of the outer barrel 104. As discussed above, the forgoing elements of the apparatus 100 can be modularized to allow the apparatus 100 to be easily transported and set up in a variety of different types of working environments.

FIG. 3 is a partially schematic, exploded isometric view illustrating an inner barrel 102 in accordance with an embodiment of the present technology. As shown in the illustrated embodiment, an attachment plate 1024 can be connected (e.g., welded) to the outer surface of the inner barrel 102. This arrangement allows the inner barrel 102 to be easily attached with (or detached from) other elements (such as the outer barrel 104 or the air chamber 108). In this embodiment, the inner barrel 102 can be coupled with the outer barrel 104 via the seal plate 1025 and the hopper plate 1026. In the illustrated embodiment, the seal plate 1027 can further be coupled with the hopper plate 1026 to secure the inner barrel 102 with the hopper plate 1026. As discussed above, the foregoing elements of the apparatus 100 can be modularized to enable easy installation/disassembly.

FIG. 4A is a schematic, cross-sectional view of inner baffles 1023 of an inner barrel 102 and outer baffles 1043 of the outer barrel 104 configured in accordance with an embodiment of the present technology. As shown in FIG. 4A, the inner barrel 102 can include a plurality of inner baffles 1023 positioned on its outer surface, and the outer barrel 104 can include a plurality of outer baffles 1043 positioned on its inner surface. In the illustrated embodiment, the inner baffle 1023 can have a taper that can be moved by the air flow, which in turn can generate turbulence as the air flow passes by. Different inner baffles 1023 can have different types of tapers. In this embodiment, the outer baffle 1043 can be in a flat shape. In other embodiments, however, the shapes of the inner baffle 1023 and the outer baffles 1043 can vary. In the embodiment shown in FIG. 4A, in order to generate sufficient turbulence for the air flow to pick up the materials 10 from the inner barrel 102, the ratio of the average height x of the outer baffle 1043 to the outer barrel diameter d1 should not exceed 40%, while the ratio of the average height y of the inner baffle 1023 to the inner barrel diameter d2 should not exceed 45%. In other embodiments, however, the number and/or arrangement of the inner baffles 1023 and the outer baffles 1043 (e.g., per cross section) can vary.

FIG. 4B is a schematic view illustrating a baffle-crossing angle θ₁ between an air flow and an outer baffle 1043 in accordance with an embodiment of the present technology. In the illustrated embodiment, the baffle-crossing angle θ₁ can be defined by the air flow direction (as shown by arrow “C” in FIG. 4B) and the outer baffle 1403. In some embodiments, the baffle-crossing angle θ₁ can have a range from about 40 to about 61 degrees. The same range can also apply to the inner baffles 1023. In other embodiments, however, the baffle-crossing angle θ₁ may have different values.

FIG. 5A is a schematic, cross-sectional view illustrating a portion of the nose cone chamber 1057 in accordance with an embodiment of the present technology. As shown in FIG. 5A, the inner surface 1055 of the nose cone 105 can includes a base layer 503 and a surface layer 504. The surface layer 504 can include the nose cone components 1051. The nose cone components 1051 can define a plurality of cavities 1052. As mentioned previously, when the air flow 501 passes through the nose cone chamber 1057, a portion of the air flow 501 can be siphoned (or sucked) into the plurality of cavities 1052 and a continual vortex flow 502 can be generated. The continual vortex flow 502 can act like a “roller bearing” and reduce a surface friction force of the surface layer 504 in the nose cone chamber 1057. This feature is expected to help prevent accumulation of sediments on the surface layer 504. Further, as discussed above, the surface layer 504 with the plurality of nose cone components 1051 can create a cyclonic effect (i.e., adding turbulence or vortex into the air flow) that can facilitate separating materials 10 in the pipeline 106.

FIG. 5B is a schematic, cross-sectional view illustrating a single nose cone component 1051 configured in accordance with an embodiment of the present technology. The nose cone components 1051, for example, can include a “wave-shaped” nose cone protrusion 505. A center line of the nose cone protrusion 505 can be substantially parallel to the base layer 503 of the nose cone 105. As illustrated in FIG. 5B, the nose cone component angle θ₂ can be at around 30 degree to the base layer 503. In other embodiments, however, the nose cone component angle θ₂ can vary based on different designs. In still other embodiments, the nose cone components 1051 may have other suitable shapes and/or arrangements.

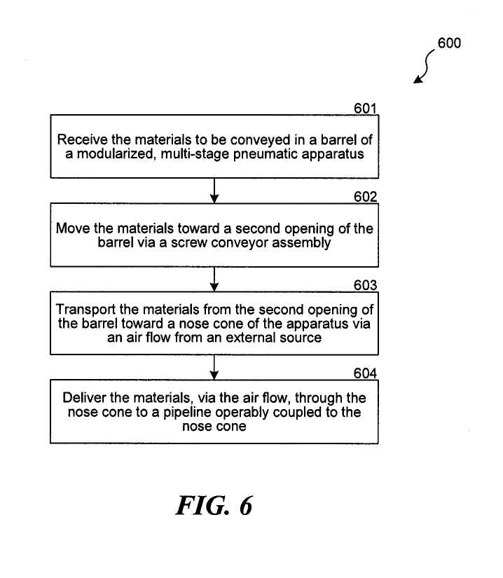

FIG. 6 is a flowchart illustrating a method 600 for conveying materials 10 from a first location to a second location remote from the first location in accordance with an embodiment of the present technology. Referring to FIGS. 1 and 6 together, the method 600 can start at block 601 by receiving the materials 10 to be conveyed in a barrel 102 of a modularized, multi-stage pneumatic apparatus 100. In the illustrated embodiment, the materials 10 are received in the barrel 102 via a hopper 103 in fluid communication with the barrel 102 via a first opening 1021 of the barrel 102. The method 600 continues at block 602 by moving the materials 10 toward a second opening 1022 of the barrel 102 via a screw conveyor assembly 101.

The method 600 can then continue at block 603 by transporting the materials from the second opening 1022 of the barrel 102 toward a nose cone 105 of the apparatus 100 via an air flow from an external source. In the illustrated embodiment, for example, the air flow facilitates transport of the materials 10 based, at least in part, on a siphon effect. The method 600 continues at block 604 with delivering the materials 10 (via the air flow) through the nose cone 105 to a pipeline 106 operably coupled to the nose cone 105. The inner surface 1055 of the nose cone 105 can include a plurality of nose cone components 1051 positioned to generate a cyclonic effect in the air flow passing through the nose cone chamber 1057.

In some embodiments, the method 600 can further include a step of operably coupling the barrel 102 (e.g., can be an inner barrel 102) to the outer 104 barrel via an attachment plate 1024 before receiving the materials 10 to be conveyed. A number of the elements used with the method 600 in accordance with an embodiment of the present technology may be modularized. In some embodiments, for example, the method 600 can further include selecting a configuration of the outer barrel 104, the inner barrel 102, the nose cone 105, and/or the screw conveyor assembly 101 based, at least in part, on a working environment and/or an attribute of the materials 10 to be conveyed.

In some embodiments, the method 600 can further include a step of separating the materials 10 into a first set of materials 20 and a second set of materials 30 as the materials 10 are transported, via the pipeline 106, from the first location to the second location. The materials can be separated based, at least in part, on the cyclonic effect in the air flow.

One feature of the present technology is that the elements of the multi-stage pneumatic apparatuses described herein may be modularized. That is, elements of the apparatus can be easily attached (e.g., installed) or detached (e.g., replacement or disassembled). Further, users can choose elements with suitable sizes so as to satisfy specific requirements for different engineering projects.

Another feature of the present technology is that the nose cone 105 of the apparatus may be configured to have a plurality of nose cone components 1051. As described above, the nose cone components 1051 are positioned to generate a cyclonic effect that is expected to reduce the inner surface friction force of the inner surface 1055 of the nose cone 105 and prevent accumulation of sediments on the inner surface 1055.

From the foregoing, it will be appreciated that specific embodiments have been described herein for purposes of illustration, but that the disclosure encompasses additional embodiments as well. For example, the inner barrel 102, the outer barrel 104, and/or the screw conveyor assembly 101 described above with reference to FIGS. 1-6 may have different configurations and/or include different features. In several embodiments, for example, the screw conveyor assembly 101 in any of the foregoing embodiments may have a different shape or different dimensions. In still other embodiments, the inner barrel 102 can have different types of opening depending on the flow path of the air flow allow. In yet other embodiments, the outer barrel 104 can be formed as an integral component.

Specific elements of any of the foregoing embodiments can be combined or substituted for elements in other embodiments. For example, more than one air blowers 107 can be used to create different types of air flows. Furthermore, while advantages associated with certain embodiments of the disclosure have been described in the context of these embodiments, other embodiments may also exhibit such advantages, and not all embodiments need necessarily exhibit such advantages to fall within the scope of the disclosure. Accordingly, the disclosure is not limited, except as by the appended claims.

I/We claim:

1. A multi-stage pneumatic apparatus for conveying materials, the apparatus comprising:
an inner barrel including a plurality of inner baffles on an outer surface of the inner barrel;
an outer barrel configured to accommodate the inner barrel, wherein the outer barrel includes a plurality of outer baffles on an inner surface of the outer barrel and facing the inner baffles;
a hopper proximate to a first end of the apparatus, wherein the hopper includes an opening in fluid communication with the inner barrel, and wherein the hopper is configured to receive and direct materials into the inner barrel;
a screw conveyor assembly at least partially within the inner barrel and configured to transport materials received from the hopper toward the outer barrel; and
a nose cone proximate to a second end of the apparatus opposite the first end, wherein the nose cone comprises an inner surface defining, at least a part, a nose cone chamber, and wherein the nose cone comprises a plurality of nose cone components on the inner surface of the nose cone,
wherein the materials to be conveyed are transported from the outer barrel to the nose cone via air flow from an external source in fluid communication with the outer barrel, and wherein the air flow facilitates transport of the materials based, at least in part, on a siphon effect.

2. The apparatus of claim 1 wherein the inner barrel is configured to be coupled with the outer barrel via an attachment plate.

3. The apparatus of claim 1 wherein the inner barrel is coupled with the outer barrel via a shoe plate and a hopper plate, and the inner barrel and the hopper plate are coupled together with a seal plate, and wherein the apparatus further comprises:
a main barrel configured to accommodate the outer barrel, and wherein the outer barrel is coupled with the main barrel the via the hopper plate.

4. The apparatus of claim 3 wherein the main barrel is further configured to be coupled with the outer barrel via a front plate, and wherein the main barrel and the outer barrel define, at least in part, a substantially air-tight chamber about the outer barrel.

5. The apparatus of claim 3 wherein the main barrel is configured to accommodate a bearing rod, and wherein the bearing rod includes at least one bearing portion and is configured to be operably coupled to the screw conveyor assembly.

6. The apparatus of claim 1 wherein the components of the apparatus are interchangable modular components, and wherein a size of the inner barrel, a size of the outer barrel, a size of the hopper, and a size of the nose cone is selected based, at least in part, on a working environment for the apparatus and an attribute of the materials to be conveyed.

7. The apparatus of claim 1 wherein a direction of the air flow relative to one of the outer baffles defines a baffle-crossing angle ranging, and wherein the baffle-crossing angle is from about 40 to 61 degrees.

8. The apparatus of claim 1, further comprising an air blower fluidly connected with the outer barrel and configured to generate the air flow that facilitates transport of the materials.

9. The apparatus of claim 1 wherein the nose cone components comprise wave-shaped protrusions, wherein a center line of each nose cone component is generally parallel with the inner surface of the nose cone.

10. The apparatus of claim 1, further comprising a pipeline operably coupled to the nose cone and configured to transport the materials to a location remote from the apparatus.

11. The apparatus of claim 10 wherein the nose cone components are configured to generate a cyclonic effect in the air flow through at least a portion of the pipeline as the air flow passes through the nose cone, and wherein the air flow in the pipeline is configured to separate the materials into a first set of material and a second set of material.

12. A system, comprising:
a modularized multi-stage pneumatic apparatus for conveying materials, the apparatus comprising—
an outer barrel;
an inner barrel at least partially received within the outer barrel and in fluid communication with the outer barrel;
a hopper in fluid communication with the inner barrel and configured to receive and direct materials into the inner barrel;
a nose cone assembly operably coupled to the outer barrel, wherein the nose cone assembly comprises an inner surface defining, at least a part, a nose cone chamber, and wherein the nose cone assembly comprises a plurality of nose cone components on the inner surface of the nose cone chamber,
a screw conveyor assembly at least partially within the inner barrel and configured to transport materials received from the hopper toward the nose cone assembly;
an air flow component in fluid communication with the outer barrel and configured to generate an air flow between the inner barrel and the outer barrel, wherein the air flow is configured to transport the materials from the inner barrel to the nose cone assembly;
a pipeline operably coupled to the nose cone and configured to receive materials from the apparatus for conveyance.

13. The system of claim 12 wherein the inner barrel comprises a plurality of first baffles on an outer surface of the inner barrel, and the outer barrel comprises a plurality of second baffles on an inner surface of the outer barrel and facing the first baffles, and wherein the first and second baffles are positioned to generate turbulence in the air flow.

14. The system of claim 12 wherein the modularized multi-stage pneumatic apparatus comprises a plurality of interchangable modular components, and wherein a size and configuration of at least one of the inner barrel, the outer barrel, the hopper, the screw conveyor assembly, and the nose cone is selected based on a working environment for the apparatus and an attribute of the materials to be conveyed.

15. The system of claim 12 wherein the nose cone components on the inner surface of the nose cone chamber comprise wave-shaped protrusions configured to generate a cyclonic effect in the air flow as the air flow passes through the nose cone chamber.

16. A method for conveying materials from a first location to a second location remote from the first location, the method comprising:
receiving the materials to be conveyed in a barrel of a modularized, multi-stage pneumatic apparatus, wherein the materials are received in the barrel via a hopper in fluid communication with the barrel via a first opening of the barrel;
moving the materials toward a second opening of the barrel via a screw conveyor assembly;
transporting the materials from the second opening of the barrel toward a nose cone of the apparatus via an air flow from an external source, and wherein the air flow facilitates transport of the materials based, at least in part, on a siphon effect; and
delivering the materials, via the air flow, through the nose cone to a pipeline operably coupled to the nose cone, wherein an inner surface of the nose cone comprises a plurality of nose cone components positioned to generate a cyclonic effect in the air flow passing through the nose cone.

17. The method of claim 16 wherein the barrel is an inner barrel, and wherein the method further comprises operably coupling the inner barrel to the outer barrel via an attachment plate before receiving the materials to be conveyed.

18. The method of claim 17, further comprising selecting a configuration of the outer barrel, the inner barrel, the nose cone, and the screw conveyor assembly based, at least in part, on a working environment and an attribute of the materials to be conveyed.

19. The method of claim 17 wherein the outer barrel and the inner barrel define a substantially air-tight chamber.

20. The method of claim 16, further comprising separating the materials into a first set of materials and a second set of materials as the materials are transported, via the pipeline, from the first location to the second location, and wherein the materials are separated based, at least in part, on the cyclonic effect in the air flow.
